(19) United States
(12) Patent Application Publication
(10) Pub. No.: US 2011/0114341 A1
(43) Pub. Date: May 19, 2011

(54) INTEGRATED FIRE FIGHTING VALVE AND SYSTEM

(76) Inventors: Paul J. Claffey, Springtown, TX (US); Thomas G. Marshall, Weatherford, TX (US)

(21) Appl. No.: 12/946,482

(22) Filed: Nov. 15, 2010

Related U.S. Application Data
(60) Provisional application No. 61/262,466, filed on Nov. 18, 2009.

(51) Int. Cl. A62C 2/00

(52) U.S. Cl. 169/13; 169/5; 137/535

(57) ABSTRACT

An enhanced fire prevention system includes a valve having three or more ports in which water is drawn from a source and diverted away from a water filtration system and directed towards a hose used to battle a fire. The valve includes a pressure relief assembly that is connected to and integrally formed within the valve. The valve may also be housed within a hydrant apparatus installed within an existing water main or irrigation lines.

### CROSS-REFERENCE TO RELATED APPLICATIONS

This application claims the benefit of U.S. Provisional Patent Application No. 61/262,466 filed on Nov. 18, 2009, titled “Integrated Fire Fighting Valve And System,” which is incorporated herein by reference.

### TECHNICAL FIELD

The systems and methods described herein relates to fire prevention devices that facilitates use of water repositories and associated equipment in close proximity to the repository where an otherwise adequate water supply may not be available for controlling fire or other applications.

### BACKGROUND

Use of fire hoses in association with a public water supply is well known. Typically, a fire hose is attached to a hydrant by firefighters to control a structure, land, or other object that is on fire. In some areas, however, a hydrant is not located in close proximity to the blaze, and an adequate source of water is not available. Particularly in rural areas, a hydrant or other source of water may be located hundreds of feet or more from a fire, meaning that another water source must be relied upon to fight the fire. Even in more densely populated areas, hydrants may be located nearby, but may be of no help. With many municipalities operating at budget deficits, hydrants and associated pipelines may be in a state of disrepair. Otherwise, hydrants may be damaged by unauthorized use or vandalism, making them unavailable when needed. In either case, the assumption that a nearby hydrant equates to an abundance of water may be incorrect.

In addition, in many rural areas, fire departments are comprised of volunteers rather than full-time career personnel. This means that the time to respond to a fire may be increased while volunteer firefighters assemble and travel to the site. In the meantime, the property owner in need of emergency assistance and without a meaningful water supply can do little to mitigate the damage to the property.

A swimming pool is usually equipped with a complex network of valves, pipes, and devices that provide circulation and filtration of the water to maintain clean and hygienic swimming conditions. Firefighters have been known to place portable pumps in swimming pools or other reservoirs to provide water under pressure through a fire hose to fight a fire in close range to a water source. A swimming pool system consists of multiple valves and pipes “hard-fitted” and permanently installed as part of the pool equipment. There are several drawbacks to these permanently installed systems. First, they consist of numerous and often unnecessary valves and pipes to prevent pool pump damage, which are not compatible with fire fighting functions and other uses, and which increase equipment installation and maintenance costs. Second, the parts of the system dedicated to the water use are permanently fixed, providing no flexibility in terms of location of use. Hard-fitted valves only direct water to the place near where the valve is situated. The flexibility required to fight fires anywhere on a property is not provided by a hard-fitted system.

### SUMMARY

The fire prevention system solves the above-described problems by providing homeowners or business owners with equipment that can be used to rapidly respond to an active fire while providing portability. A three-way or four-way valve is situated in locations throughout the swimming pool filtration and pump system that allows a user easy access for fire hose connection where needed to address a fire at various locations on the property. Unlike prior art systems that employ complex hard-fitted valve and pipe arrangements to address a condition of a blockage that impedes the flow of water through the fire hose and potentially to and from the swimming pool pump and other equipment, the system employs an integrated valve. This integrated valve permits selected water flow to the fire hose and at the same time provides relief to the system in the event of a blockage condition. The valve and associated system offers property owners with equipment that along with water from a swimming pool, spa or other water source may be used in a fire emergency. In addition, when water from a chlorinated swimming pool or spa is used, an in-line cartridge that largely removes chlorine from the water is provided. The in-line cartridge for chlorine removal allows use of pool or spa water for other purposes such as irrigation, house or sidewalk cleaning, etc. without introducing significant levels of chlorine to the environment.

The fire prevention system offers the additional benefit of providing water removal capability from a desired location. For example, many swimming pools may be constructed with inadequate or non-existing overflow prevention capabilities. In such circumstances, heavy rain can place a swimming pool in an overflow condition. Swimming pools that overflow or crest may cause serious damage when the pool is situated in close proximity to doors of a residence or valued areas. In these cases, the fire prevention system may be used to draw water from the pool and return to pool's water to a safe level.

### BRIEF DESCRIPTION OF THE DRAWINGS

FIG. 1 illustrates a swimming pool and associated water filtration and circulation equipment of the firefighting system incorporating an integrated four-way valve assembly.

FIG. 2 illustrates swimming pool water filtration and circulation equipment of the firefighting system.

FIG. 3 illustrates a valve of the firefighting system.

FIG. 4 illustrates a view of a residential property having an in-ground irrigation/sprinkler system.

FIG. 5 illustrates a view of a property having an in-ground irrigation/sprinkler system with hydrants of the firefighting system installed at various locations.

FIG. 6 illustrates a side view of an installed yard utility/hydrant application with an irrigation/sprinkler system.

FIG. 7 illustrates a side view of an installed yard utility/hydrant application with a water main line.

FIG. 8 illustrates a valve of the fire prevention system.

FIG. 9 illustrates a valve of the fire prevention system.

FIG. 10 illustrates a valve of the fire prevention system.

### DETAILED DESCRIPTION

A number of hazards can threaten a property owner, perhaps none is more threatening than fire. Fire hydrants are typically installed in residential and commercial areas at locations viewed to be available to a number of properties within the immediate area. In rural settings, however, fire hydrants (if available at all) may be situated more sporadically. In fact, many rural residents are not connected to a municipal water supply, but instead obtain water through a well. In addition, although residents in more densely populated areas seemingly have access to water for fire fighting purposes because of close proximity to a hydrant, the hydrant may be inoperable due to age or vandalism. Although a municipality may be responsible for maintaining hydrants in good working order, various factors such as its staffing or budget constraints may inhibit a municipality's ability to properly maintain hydrants.

The firefighting system resolves these problems by providing property owners with the ability to draw from existing water sources, such as swimming pools, spas, ponds, irrigation systems or a water main line to combat fire. The system advantageously provides an integrated three-way or four-way valve that alleviates the threat of damage to pool or spa equipment. The system also provides portability that prior art systems do not. This allows combating a fire from different locations throughout a property, rather than only from a single location.

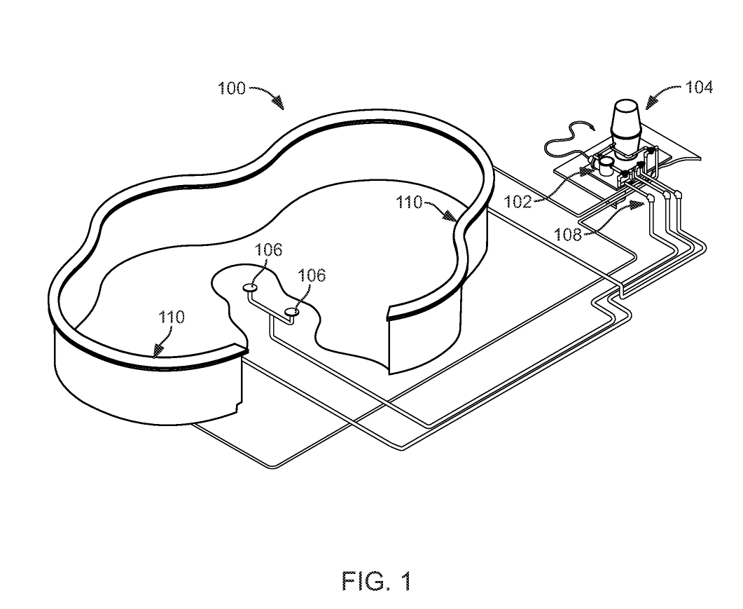

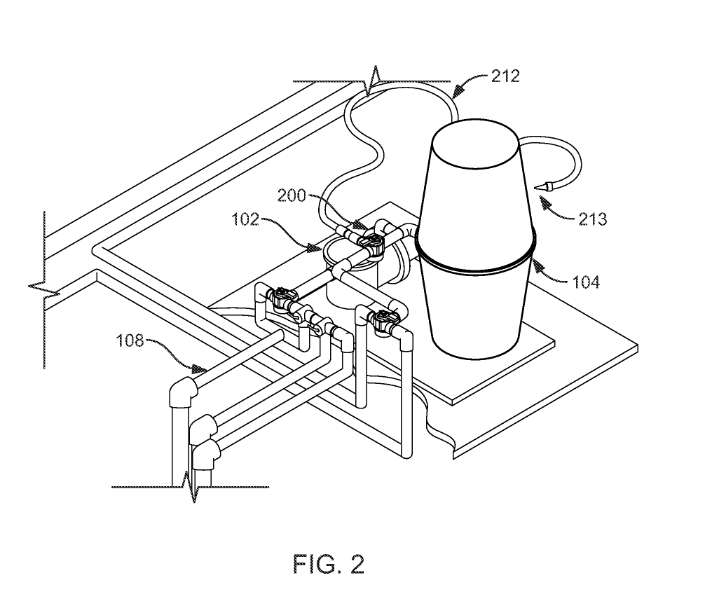

FIGS. 1 and 2 reflect an embodiment of the basic equipment and structure of the firefighting system. Although this embodiment of the system is integrated with the pump and filter equipment associated with a swimming pool, application of the system is not so limited and may be adapted to draw water from other sources such as ponds, lakes, streams or water storage tanks. The structure and operation of the depicted equipment is described here only to the extent necessary to describe the system.

FIG. 1 depicts a conventional swimming pool 100, a pump 102 and a filter 104. A back-wash valve may be associated with filter 104. Pool 100 is typically filled with water and is an excellent source of water for fighting a fire. Continuing with FIG. 1, one or more of pipe 108 connects the swimming pool 100 with the pump 102. The pump 102 operates to draw water from pool 100 through ports located at multiple drain points 106 at the bottom of the pool 100 and/or skimmer points 110 located near the water surface and to direct the water to filter 104 for water filtration. Pump 102 typically pumps water in the 40 to 200 PSI range. The polyvinyl chloride (PVC) pipe normally utilized in connection with swimming pools and spas associated with homes usually has a burst capacity of approximately 330 PSI. It is a feature of the system that the fire fighting equipment of the systems and methods is designed to function with the swimming pool and related water circulating equipment that are already in commercially available and, in some cases, already installed in homes and the like.

FIG. 2 is a more detailed view of the swimming pool water circulation and filtration equipment of the fire prevention system. Fire hose 212, equipped with nozzle 213, is attached to the water pump 102 and pool filtration system 104 at valve 200.

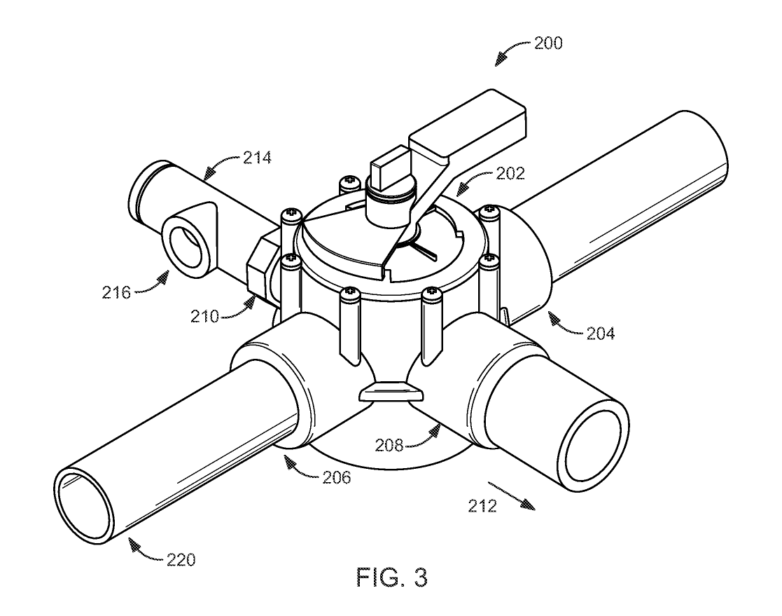

FIG. 3 depicts the valve used in the firefighting system. Valve 200 includes hub portion 202 having four ports 204, 206, 208 and 210. A first port 204 receives water from an existing water source, such as swimming pool 100. The water is directed to the first port 204 of valve 200 by pump 102. Water may leave the valve 200 through a second port 206. In the disclosed swimming pool configuration, a pipe 220 connects second port 206 to the swimming pool filter 104 and facilitates normal circulation of the pool water.

Under normal, non-emergency operation, water from swimming pool 100 entering valve 200 at a first port 204 passes through valve 200 to a second port 206. This results from valve 200 being set so first port 204 and second port 206 are in an open condition with the port 208 closed. In this state, water flowing into the first port 204, through valve 200 and out of second port 206 returns to the pool filter 104 of swimming pool 100. Under these normal conditions virtually all of the water removed from swimming pool 100 is returned to the pool through second port 206.

When operating the system and valve 200 in fire emergency mode, the third port 208 and fourth port 210 of valve 200 are employed. In emergency mode, water continues to be drawn from swimming pool 100 using pump 102. Water arrives at valve 200 via port 204. In emergency mode, however, the second port 206 for returning water to pool 100 is closed within the hub 202 of valve 200 and the third port 208 is open. A fire hose 212 may be detachably connected to third port 208 via a fire hose thread. Typically, this is a one and one-half inch thread, but could be of various sizes (through use of by example, couplings) to accommodate various hose sizes. In emergency mode, water from pool 100 is directed to the valve 200 by pump 102 and is directed further to open third port 208, rather than second port 206, which is closed either manually or automatically. Thus, water is available for control of small fires and is not returned to the pool 100.

Valve 200 also includes a fourth port 210 as an integrated safety feature to prevent damage to pump 102 and other equipment. Within fourth port 210 is a pressure relief valve 214. Pressure relief valve 214 may be a spring loaded valve that is forced into an open position when pressure exerted on the valve reaches a predetermined level. During normal emergency operations, no water escapes relief valve 214 via port 210. In operation, water flow through fire hose 212 may be impeded if the hose 212 is crimped, has a blockage or if a nozzle 213 attached to hose 212 is placed in the closed position. In these circumstances, pump 102 continues to operate yet pumped water has no way in which to escape the system. This reverse pressure may cause damage to pump 102. To solve this problem in an efficient and cost effective manner, a spring loaded valve 214 located at fourth port 210 responds to the built up water pressure by forcing the spring loaded flap or plunger within spring loaded valve 214 to the open position. As a result, water that was otherwise blocked escapes from the fourth port 210 via opening 216 of spring loaded valve 214, relieving reverse pressure upon pump 102. This released water may simply spill to the ground. Alternatively, an overflow conduit may be attached between opening 216 of spring loaded valve 214 and the pipe 220 leading from second port 206 back to filter 104. In this manner, excess water is not wasted but remains available for fire-prevention purposes. In addition, the integration within valve 200 of this pressure relief function eliminates complex pipe and valve networks that add considerable expense in terms of installation and maintenance.

In accordance with the system, valve 200 is incorporated into piping that connects the pump 102 with the filter 104. In normal operation mode (non-emergency) the four-way valve 200 is set for continuous water flow from the pump 102 to filter 104 via a backwash valve. A fire hose 212 is detachably connected to the four-way valve 200 through connecting pipe 206. Under normal, non-emergency operation, the four-way valve 200 is turned, either manually or automatically, into a position where all or substantially all of the water flow is directed to filter 104. In emergency mode, the four-way valve is set, either manually or automatically for all or substantially all of the water flow to be directed towards fire hose 212, with no or almost no water being directed back to the pool filter 104. The four-way valve 200 serves the purposes of directing water in the desired manner as well as providing a safeguard to protect expensive pool equipment from damage in the event of a hose blockage. Operator safety is also promoted as injury to the operator in close proximity to a valve, hose or other pool equipment under excessive pressure is likely.

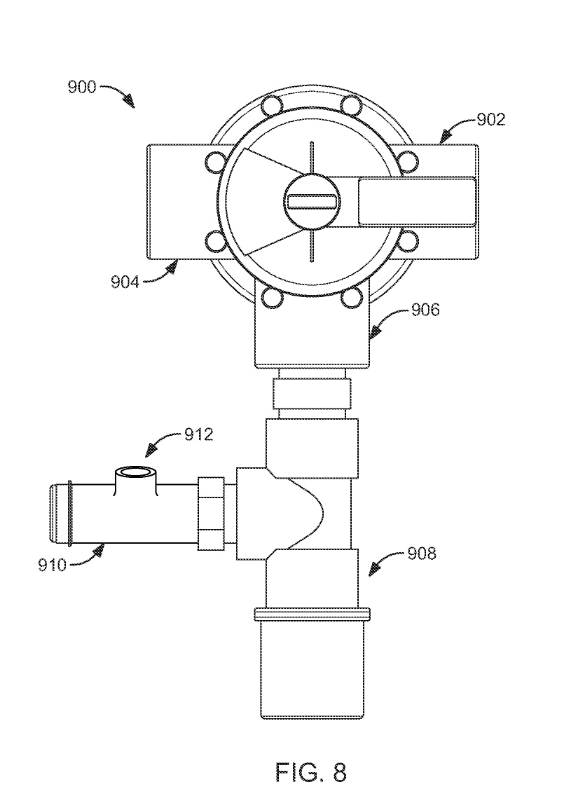

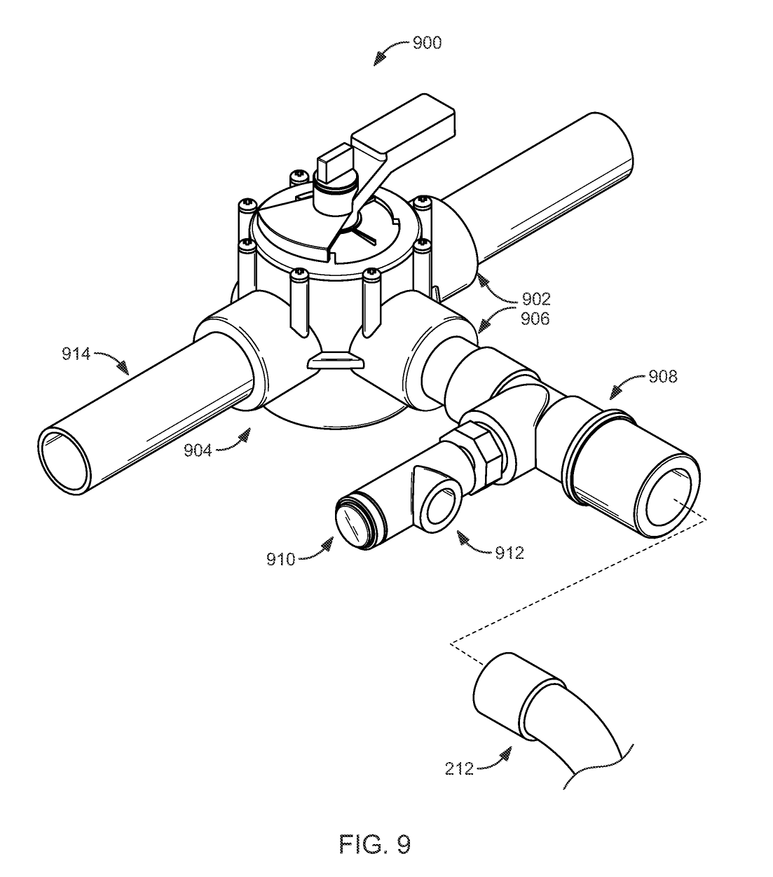

Another embodiment of the fire prevention valve is depicted in FIGS. 8 and 9. In FIGS. 8 and 9, a three-way valve 900 in which a pressure relief valve 910 is incorporated is shown. In this valve configuration, water from a pool or reservoir is drawn from a pump and enters valve 900 at a first port 902. Under non-emergency operations, the water flows through valve 900 and exits at port 904 and proceeds to be filtered by the swimming pool filtration equipment. In fire prevention operations, water is drawn from a pool or reservoir by a pump and enters valve 900 at a first port 902. Second port 904, however, is closed manually or electromechanically and a third port 906 is placed in an open state. A fire hose 212 is attached at the end of a fitting 908 that is connected (either detachably or rigidly) to valve 900 at third port 906. On one port of fitting 908 is attached a pressure relief valve 910. Pressure relief valve 910 is a spring loaded valve that may include a flap that is hinged in a manner that allows it to be in an open or closed state or a plunger that is compressed into an open state when subjected to a predetermined pressure. Under operations when there is no obstruction in fire hose 212 to prevent water from exiting valve 900 at port 906, the pressure relief valve 910 is in a closed state. This means that water exits port 906, traverses fitting 908, and flows through fire hose 212 attached at the end of fitting 908. In a situation where fire hose 212 is obstructed, either through crimping or pinching of hose 212 or debris or an object blocking water flow, accumulated pressure within valve 900 will cause the flap or plunger of spring loaded pressure relief valve 910 to move to the open state. In the open state, water will escape the valve 900 through opening 912 of pressure relief valve 910. In this manner, damage to pool pump, valve 900 and/or other pool equipment is avoided. The amount of pressure necessary to trip pressure relief valve 910 depends on valve and pool pump specifications. An overflow conduit may be attached between opening 912 and water return pipe 914, allowing water to return to the swimming pool, rather than spilling on the ground. In FIGS. 8 and 9, pressure relief valve 910 is situated in a largely perpendicular position to fitting 908 in this three-port valve structure, but other configurations based on equipment size or space restrictions may be utilized.

Since fitting 908 may be detachably connected to valve 900, a user may transport the fitting 908, including pressure relief valve 910 and attached fire hose 212 from a first property to a second property equipped with a multi-port valve of the fire prevention system. This provides the added economic benefit of using a single fire prevention system at multiple locations. The portability advantages of the system and valve are realized further by locating a valve 900 at multiple locations between fire hose 212 and pump 102. In this manner, fire hose 212 may be detachably installed at various locations throughout the property to address a blaze. This overcomes limitations of hose length, which is a significant issue on larger properties having multiple structures or other areas that may be susceptible to fire.

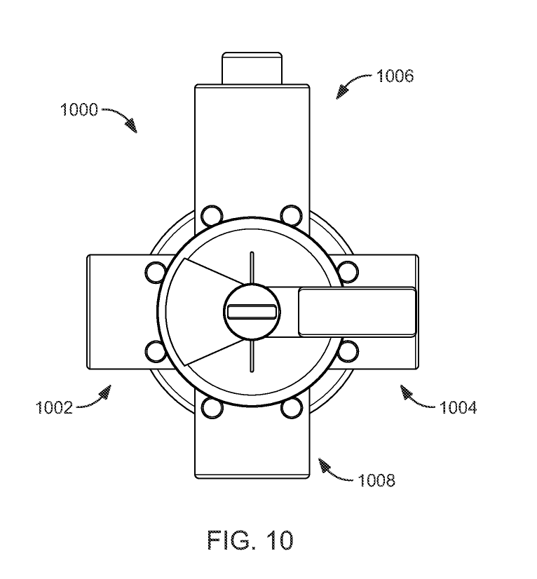

Another embodiment of the fire prevention system is depicted in FIG. 10. In accordance with the system, a four-way valve is incorporated into traditional swimming pool pump and filtration equipment as described above. In another embodiment of the system, the pressure relief component of the fire-prevention system resides within a fourth port of the fire prevention valve. Referring to FIG. 10, a spring-loaded valve similar in operation to pressure relief valves 214 and 910 discussed above that is integrally formed within one port of the four port valve. Spring loaded valve may include a hinged flap or plunger that moves from a closed to open position upon accumulation of a predetermined pressure within valve 1000. Valve 1000 has four ports 1002, 1004, 1006, and 1008. Under normal pool operation, pool water from pool pump 102 enters the valve 1000 at port 1002 and is returned to the pool via port 1004, which is in an open state. Port 1006 is in a closed position. Under normal pressure conditions in fire-prevention mode where pressure relief is not invoked, the spring loaded valve integrated within valve 1000 at port 1008 is in a closed position. This means that substantially all water flows into valve 1000 at port 1002 and flows out of valve 1000 at port 1006, and subsequently through a fire hose 212 that may be detachably connected to port 1006. In fire prevention mode, port 1006 is closed. In a state of excessive pressure during fire prevention operations caused by an obstruction preventing water to exit valve 1000 at port 1004, the spring loaded relief valve integrated into port 1008 will move to an open position and allow the release of water through port 1008. As in other described embodiments, a conduit may be attached between port 1008 and a pipe connected to port 1004, allowing return of the released water to the pool.

Referring back to FIGS. 3, 8, 9 and 10, fire hose 212 may be detachably connected to valve 200, 900 or 1000. Fire hose 212 may be of varying lengths. Fire hose 212 may be of the type typically 1½ inches in diameter, with a burst capacity of up to approximately 400 PSI. In one particular embodiment, the burst capacity of the fire hose 212 is approximately 250 PSI. The end of fire hose 212 may be equipped with a standard nozzle 213. Various swimming pool pumps 102 operate to provide water output pressure in the 20 to 200 PSI range. Water output flow for fighting a fire in the range of 70 to 120 gallons per minute may be achieved by pump 102.

The various parts of the system may be made available to a customer in a kit. This kit enables swimming pool installers as part of new pool construction to install the fire-prevention system. Alternatively, the valve 200 and associated equipment of the system may be installed in existing pool systems. As much of piping for swimming pools is made of PVC, valve 200, 900 or 1000 may be easily cut into existing plumbing to provide the valve 200, 900 or 1000 at any desired location. In addition, existing valves may be easily replaced by valve 200, 900 or 1000. The kit offered to consumers may include the fire hose 212, valve 200, 900 or 1000, associated fitting pipes, and a nozzle 213. This kit allows for easy modification of a traditional pool system into a valuable water source to be used in an emergency.

Another embodiment of the fire fighting equipment of the system integrated within a conventional swimming pool and swimming pool water circulating system includes the additional feature of an in-line water dechlorinating unit, such as a filter. The dechlorinating unit may be of the size and type commercially available and may be installed, for example, in valve 200 of FIG. 3 between the third port 208 of valve 200 and fire hose 212. Alternatively, a de-chlorinating unit may be manufactured in a size and shape that allows it to be inserted within third port 208 of valve 200, making additional pipe cutting unnecessary and accommodating easy post-installation use. This in-line dechlorination unit facilitates alternative use of pool water for cleaning or irrigation, when other sources of water may not be available.

The safety and performance advantages described above in connection with firefighting valves described 200, 900, and 1000 may also be incorporated in a valve having more than four ports. For example, today's swimming pools may include complex operation and entertainment features, including a spa, multiple water falls, water return jets, slides and the like. In order to supply the necessary water to these features, valves having more then four ports may be utilized within the pool's water circulation and filtration plumbing network. These valves may reside at various locations within the pool water circulation and filtration network. Accordingly, the firefighting capabilities and water pressure relief valves described above may be incorporated into various ports of the valves having more than four ports. For example, a valve having seven ports with five ports serving water intake for filtration from various locations of the pool and water return to various locations will have available two additional ports. One additional port may be used for connection of a fire hose and another port may have incorporated a pressure relief valve. Operation of this valve having more than four ports is similar to operation of the valves discussed above. In non-emergency operations, the five ports of the valve dedicated to water circulation will facilitate the intake of water from the pool for filtration and the return of water to the pool, via various return points located at or within the pool, after filtration. In emergency mode, the return ports for returning water to the pool will be closed, with the intake port remaining open to draw water from the pool. The port to which the fire hose is connected will remain open, as well. Another port to which a pressure relief valve is attached or integrated is active during emergency operations, as discussed above. If there is a blockage in the fire hose that causes pressure build up within the multi-port valve, the pressure relief valve will “open” and built up water within the valve will be released out of the associated valve port.

Those skilled in the art will recognize the advantages of the above-described system and valve in view of the foregoing disclosure. The integrated four-way valve and accompanying system installed in conventional swimming pool systems provides a portable fire prevention and control system and pool equipment safety features. The system also permits introduction of a dechlorination feature enabling use of water from a swimming pool for other uses while removing low-levels of chlorine found in residential swimming pools. One example may be insertion of an in-line filter that provides dechlorination capability. Several applications of the systems and methods may become readily apparent to those skilled in the art in light of the foregoing disclosure.

### Yard/Utility Hydrant Variant

A second system is presented to offer similar benefits of water provisioning as discussed above in the swimming pool/pond application of the fire prevention system. This system includes the various reverse pressure relief aspects described above that may damage plumbing and valve components. In this second system, however, pressure is provided from a water main line stemming from a municipal water supply line rather than a swimming pool or lake utilizing a pump. As will be discussed below, when the valve arrangement of the system is installed in the main water supply line passing through a commercial or residential property, a high pressure water supply capability is achieved without the need for a pump or electricity. Further, for properties having installed irrigation/sprinkler systems, multiple valve boxes of the system may be installed at locations on existing pipes leading to sprinkler heads. This provides the added benefit of easy installation of multiple ports or “hydrants” throughout the property for fire prevention measures. This yard/utility employs a similar concept as described in the pool/pond embodiment. This system allows the user the same capabilities as previously acknowledged with the additional advantages discussed below. In addition, the yard/utility hydrant operates to provide water output pressure in the 50 to 100 PSI range. Water output flow for fighting a fire in the range of 30 to 50 gallons per minute may be achieved through main line or sprinkler system installation. The water main line on a particular property may stem from a municipal water supply or a ground well-water supply. Even with water supplied to a main line through a well, pressure and output capacity similar to the ranges discussed above are achieved, making the fire prevention system equally effective when based on a well-water source.

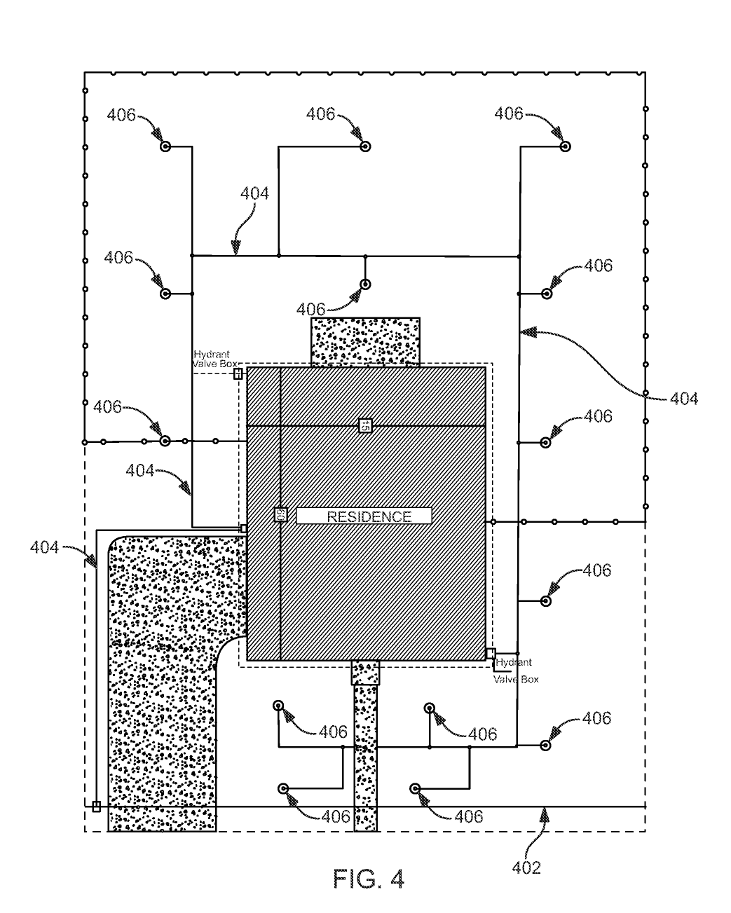

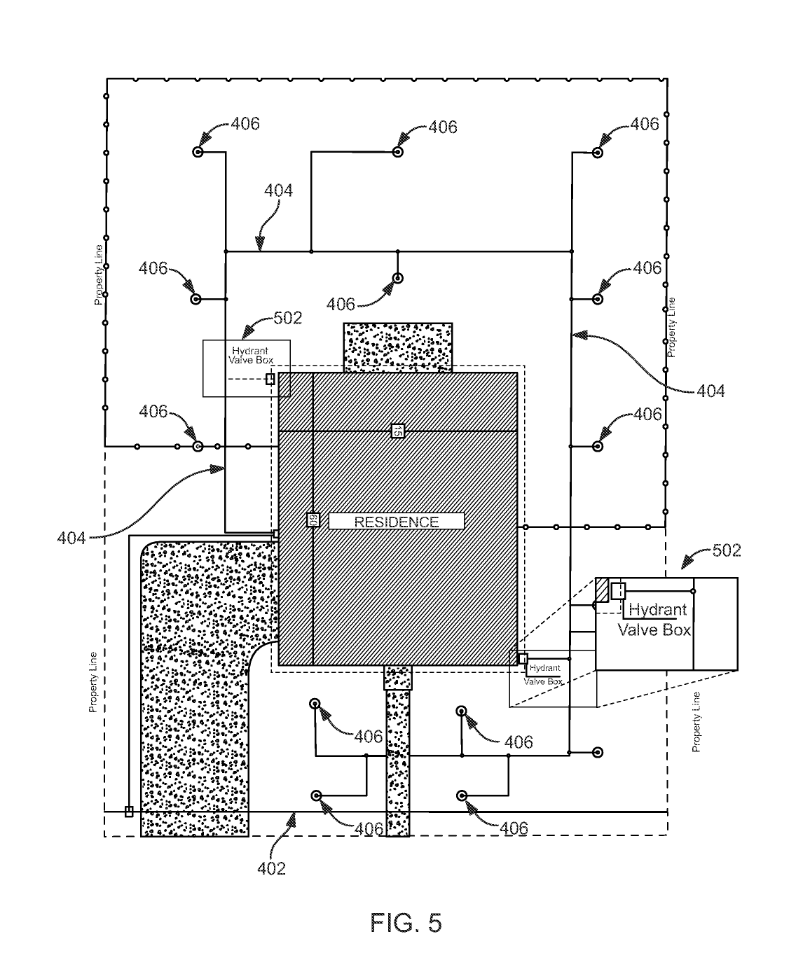

FIG. 4 depicts an aerial view of a property having an installed in-ground irrigation system. As may be seen in FIG. 4, water is supplied to various sprinkler heads 406 situated throughout the property. The sprinkler heads are tied to the water main line 402 by various irrigation lines 404. The kit may be installed into any existing residential/commercial sprinkler irrigation system, as shown in FIG. 4, be it above or below ground. No external pump is required. FIG. 5 depicts the residence having an in-ground irrigation system with multiple hydrants valve boxes 502 installed at convenient desired locations. One or more of the valve 200, 900 and 1000 described above may be installed within hydrant valve boxes 502 to provide fire prevention capability similar to that provided by a pool or pond system. Using valve 200 as an example, a hydrant valve box 502 including valve 200 may be installed along any irrigation line 404 of a sprinkler system. When installed in a sprinkler system within an irrigation line 404, water enters valve 200 at port 204. Under normal conditions (non-emergency), water leaves valve 200 at port 206 and remains within irrigation line 404. Port 208 of valve 200 is in a closed state. In fire prevention mode, port 206 of valve 200 may be closed manually through hub 202 and port 208 is opened. This allows water to be directed to a fire hose 212 attached at port 208. Pressure relief valve 214 is provided to relieve pressure caused by a blockage in fire hose 212. In this manner, hydrant valve box 502 makes available to property owners fire prevention capability from an existing water source. Either valve 200, 900 or 1000 may be installed within hydrant valve box 502. Alternatively, a hydrant valve box 502 equipped with a valve 200, 900 or 1000 may be installed directly into a water main line 402 to provide similar fire prevention capability.

With the addition of an in-line contamination prevention device (check valve), recommended for portable water delivery, the system may be installed on any existing residential or commercial main water line. No external pump is required.

This system negates water volume restrictions associated with the size of the source for which the system has been adapted. Multiple hydrant valve boxes 502 may be integrated into one system at various convenient locations, as shown in FIG. 5. Electricity is not required for operation.

In addition to providing mitigation of fire threat risk, the yard/utility hydrant variant offers a wide range of flexible utility options. With external accessories the tool can be used for high volume pressure wash, irrigation, agricultural applications, etc.

### Installation

Sprinkler/Irrigation Systems

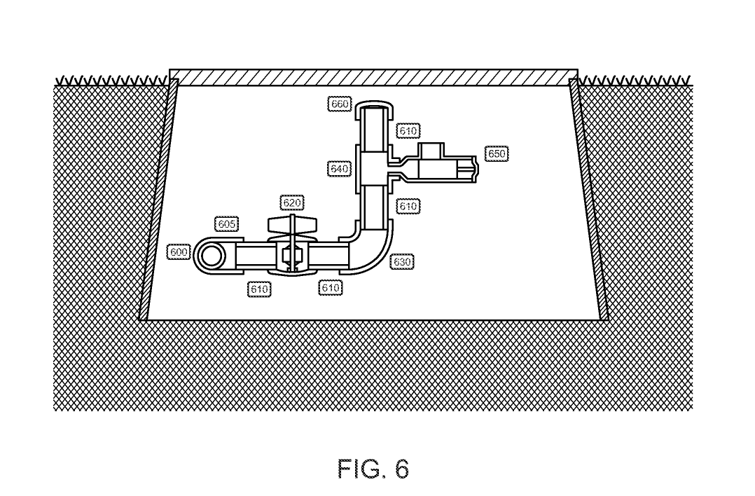

FIG. 6 depicts the fitting arrangement of the sprinkler/irrigation fire prevention system. Water source line 600 may be any of the irrigation lines 404 discussed in reference to FIG. 4. Water source line 600 is exposed then severed to allow for the placement of a PVC tee 605. An extension/nipple 610 is threaded into the non-line port of the tee 605. The opposite end of the extension is threaded into a two-way ball valve 620 that extends 610 into a 90 degree elbow 630. Again, an extension 610 is adjoined to allow for the incorporation of a second tee 640. A pressure relief valve 650 is threaded into the third port of this tee to provide a safety feature designed for the prevention of excessive back pressure unexpectedly initiated by hose or nozzle constriction. This feature prevents potential joint failure that could lead to user injury, uncontrolled water flow or equipment damage. The system is completed with the addition of a final extension 610 in which the fire hose will be attached for use. When dormant this extension is capped with cap 660 to maintain line cleanliness. All components are PVC (fittings—Schedule 40, extensions—Schedule 80).

Main Line Systems

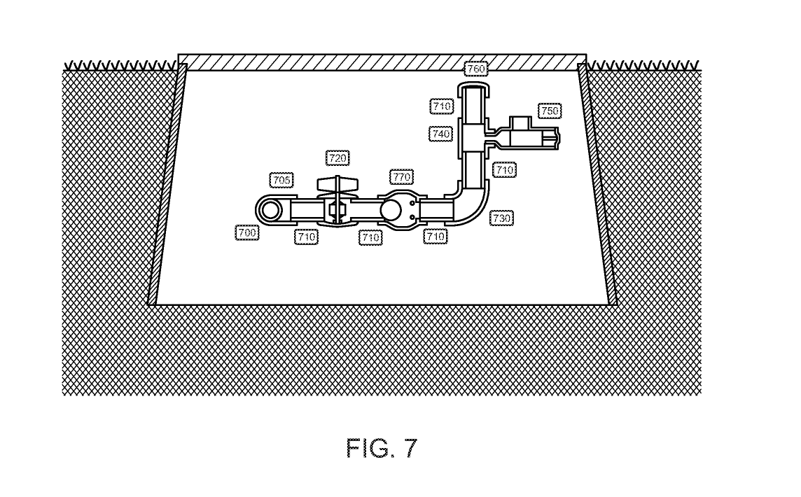

Main line system installation may be understood by reference to FIG. 7. The existing main water line 700 may be a municipal water supply line or a supply line from a well. Main water line 700 is exposed then severed to allow for the placement of a PVC tee 705. An extension/nipple 710 is threaded into the non-line port of the tee. The opposite end of the extension is threaded into a two-way ball valve 720 consequently extended with another extension 710 into a check valve 770 for the prevention of backflow contamination. This feature is required to protect purification of portable water supplies. The check valve is connected via extension 710 into a 90 degree elbow 730. Another extension 710 is adjoined to allow for the incorporation of a second tee 740. A pressure relief valve 750 is preset at a threshold value of, for example, 100 PSI and is threaded into the third port of this tee to provide a safety feature designed for the prevention of excessive back pressure unexpectedly initiated by hose or nozzle constriction. This feature is required to prevent potential joint failure that could lead to user injury, uncontrolled water flow, or equipment damage. The system is completed with the addition of a final extension 710 in which the fire hose will be attached for use. When dormant this extension is capped 760 to maintain line cleanliness. All components are PVC (fittings—Schedule 40, extensions—Schedule 80).

In an alternative embodiment, placement of a valve 200, 900, or 1000 within a main line 402 or irrigation line 404 within a plumbing network will make water available to various locations on a property while at the same time making available to safety features discussed above. The operation of this pressure relief valve installed in a water main line 402 or irrigation line 404 is similar in operation discussed in connection with FIGS. 2, 8, 9, and 10. Valve 200, 900, or 1000 in normal operation mode will have two ports open to allow water to flow as would a normal main or irrigation line. In emergency mode, water enters the valve and is directed to a port to which a fire hose is connected. The output port that allows water to flow to locations in normal mode is closed. The pressure relief portions of valves 200, 900, and 1000 provide an avenue for water escape in situations where pressure within valve 200, 900, and 1000 exceeds a preset limit, due to fire hose blockage. When valve 200, 900, or 1000 is installed in a water main line or irrigation line, the ports of the valve may be sized to accommodate the diameter of pipes used in those plumbing networks. Multiple installations of valve 200, 900, or 1000 in water main or irrigation lines provides portability and flexibility, making water available at multiple locations on larger properties.

Those skilled in the art will recognize the advantages of the above-described system and yard/utility hydrant in view of the foregoing disclosure. The yard/utility hydrant system installed in conventional residential or commercial irrigation system or existing water supply line provides a fire prevention and control system and associated safety features. Several modifications of the systems may become readily apparent to those skilled in the art in light of the foregoing disclosure.

What is claimed as new and desired to be protected by Letters Patent of the United States is:

1. A fire prevention system for drawing water from a source, comprising:
(a) a valve having three ports;
(b) a pump;
(c) a hose for detachable connection to a first of the three ports of the valve; and
(d) a pressure relief assembly integrated within a second of the three ports of the valve.

2. The system of claim 1 wherein the pressure relief assembly integrated within the second port of the valve is spring loaded.

3. The system of claim 2 wherein the spring loaded pressure relief assembly assumes an open position upon accumulation within the valve of in excess of a predetermined amount of water pressure.

4. A system for fire prevention, comprising:
(a) a primary water supply;
(b) a water diverter having at least three ports;
(c) an above-ground water access port; and
(d) a pressure relief assembly connected to a first of the at least three ports of the water diverter.

5. The system of claim 4 wherein the pressure relief assembly connected to a first of the at least three ports of the water diverter is spring loaded.

6. The system of claim 5 wherein the spring loaded pressure relief assembly assumes an open position upon accumulation within the valve of in excess of a predetermined amount of water pressure.

7. The system of claim 6, further comprising a hose that is detachably connected to a second port of the water diverter having at least three ports.

8. The system of claim 4 wherein the primary water supply is an irrigation system water supply line.

9. The system of claim 4 wherein the primary water supply is a municipal water supply line.

10. The system of claim 9, further comprising a check valve, wherein the check valve prevents backflow of water into the municipal water supply line.

11. The system of claim 4 wherein the primary water supply is a swimming pool.

12. The system of claim 4, further comprising a hose that is detachably connected to the pressure relief assembly.

13. The system of claim 4 wherein the pressure relief assembly is integrated into a first of the at least three ports of the water diverter.

14. The fire prevention system of claim 4, further comprising a conduit connecting the pressure relief assembly and a water return line.

15. A valve comprising:
(a) four ports;
(b) a pressure relief assembly integrated within a first port of the four ports; and
(c) a spring loaded section having a closed position and an open position;
wherein the spring loaded section moves from the closed position to the open position when the water pressure within the valve exceeds a predetermined level.

16. The valve of claim 15 wherein the spring loaded section is integrated into the pressure relief assembly.

17. The valve of claim 15 wherein a second port of the four ports detachably receives a hose.

18. A fire prevention system, comprising:
(a) a valve having at least four ports;
(b) a primary water supply line;
(c) a hose;
(d) a pressure relief assembly integrated into one of the at least four ports of the valve; and
(e) a spring loaded section having a closed position and an open position;
wherein at least a first of the at least four ports is an above-ground access port.

19. A valve comprising:
(a) at least four ports;
(b) a pressure relief assembly integrated within a first port of the at least four ports; and
(c) a spring loaded section having a closed position and an open position;
wherein the spring loaded section moves from the closed position to the open position when the water pressure within the valve exceeds a predetermined level.

20. A fire prevention system, comprising:
(a) a valve having four ports;
(b) a primary water supply;
(c) a hose that is detachably connected to a first of the four ports of the valve;
(d) a pressure relief assembly integrated into a second of the four ports of the valve; and
(e) a spring loaded section having a closed position and an open position;
wherein the spring loaded section moves from the closed position to the open position when the water pressure within the valve exceeds a predetermined level.
